(19) United States
(12) Patent Application Publication
(10) Pub. No.: US 2020/0257150 A1
(43) Pub. Date: Aug. 13, 2020

(54) PIXEL STRUCTURE, DISPLAY PANEL THEREOF USING SAME, AND MANUFACTURING METHOD THEREOF

(71) Applicant: HKC Corporation Limited, Shenzhen City, Guangdong (CN)

(72) Inventor: Beizhou HUANG, Shenzhen City, Guangdong (CN)

(21) Appl. No.: 16/461,999

(22) PCT Filed: Sep. 18, 2018
(86) PCT No.: PCT/CN2018/106147

§ 371 Date: May 17, 2019

(30) Foreign Application Priority Data
Sep. 7, 2018 (CN) 201811042619.3

(51) Int. Cl. G02F 1/1362; G02F 1/1335

(52) U.S. Cl. CPC G02F 1/1362; G02F 2001/13625; G02F 2001/136222; G02F 1/133514

(57) ABSTRACT

A pixel structure comprises: a plurality of pixel units, each: a translucent region including a main translucent region and a sub translucent region disposed adjacent to each other; and a color filter structure disposed in the translucent region, and including a first color filter layer, a second color filter layer, a third color filter layer, a first sub color filter layer disposed oppositely to the first color filter layer, a second sub color filter layer disposed oppositely to the second color filter layer, and a third sub color filter layer disposed oppositely to the third color filter layer; the first color filter layer, the second color filter layer, the third color filter layer disposed in the main translucent region; and the first sub color filter layer, the second sub color filter layer, and the third sub color filter layer disposed in the sub translucent region.

### BACKGROUND OF THE INVENTION

### Field of Invention

The present invention generally relates to a pixel structure design, and especially to a pixel structure, a display panel thereof using the same, and manufacturing method thereof.

### Description of Related Art

A liquid crystal display (LCD) is usually composed of a color filter (CF) substrate, a thin film transistor (TFT) array substrate and a liquid crystal layer disposed between the color filter (CF) substrate and the thin film transistor (TFT) array substrate. The working or operation principle of the liquid crystal display (LCD) is: liquid crystals in the liquid crystal layer can be rotated and controlled by a driving electric field applied on the color filter (CF) substrate and the thin film transistor (TFT) array substrate, and then light is reflected from a back light module, so that an image can be shown. According to the orientation types of the liquid crystals, a current market has many different types for the liquid crystal display (LCD), such as: a vertical alignment (VA) type liquid crystal display (LCD), a twisted nematic (TN) type liquid crystal display (LCD), a super twisted nematic (STN) type liquid crystal display (LCD), an in-plane switching (IPS) type liquid crystal display (LCD), a fringe field switching (FFS) type liquid crystal display (LCD), etc.

The above-mentioned vertical alignment (VA) type liquid crystal display includes, for example, a patterned vertical alignment (PVA) type liquid crystal display or a multi-domain vertical alignment (MVA) type liquid crystal display, wherein a fringe field effect and a compensation plate are used to achieve a wide viewing angle effect for the patterned vertical alignment (PVA) type liquid crystal display. On the other hand, a pixel is divided into a plurality of regions and a protrusion or a specific pattern structure is used for the multi-domain vertical alignment (MVA) type liquid crystal display, so that liquid crystal molecules in different regions can be inclined to different directions to achieve the wide viewing angle effect.

According to the above-mentioned in-plane switching (IPS) type liquid crystal display (LCD) or the fringe field switching (FFS) type liquid crystal display (LCD), liquid crystal molecules are driven in a direction parallel to an in-plane direction of a substrate corresponding to an electric field applied on the substrate and contains a component substantially parallel to the in-plane direction of the substrate. The in-plane switching (IPS) type liquid crystal display (LCD) and the fringe field switching (FFS) type liquid crystal display (LCD) have an advantage of the wide viewing angle. However, since the wavelength of the blue light is shorter than the wavelength of red and green light, the retardation of the blue light required to achieve the same transmittance is smaller than the retardation of red and green light. The transmittance—voltage (VT) curves of red, green and blue light are different, and the transmittance of red, green and blue light in the panel of polyimide (PI) film, planarization layer (PFA), coating layer (OC) and other membrane surfaces are different, so that color cast problems are generated easily.

Furthermore, in the multi-domain vertical alignment (MVA) type liquid crystal display, a current mainstream method is to divide a pixel into bright regions and dark regions, so that two transmittance-voltage (VT) features can be mixed for good optical performance. In addition, if the proportion of bright regions and dark regions can be adjusted properly, a whitening problem in a gray scale will be effectively solved for the large angle of view.

### SUMMARY OF THE INVENTION

For resolving the technical problems above-mentioned, the objects of the present invention are to provide a pixel structure design, and especially to a pixel structure, an display panel using the same, and manufacturing method thereof. The present invention can resolve color cast problems effectively and improve a pixel aperture rate effectively.

The objects and technical solutions of the present invention are implemented by following technical ways and means. In one perspective, the present pixel structure comprises a plurality of pixel units, wherein each of the pixel units comprises: a translucent region, wherein the translucent region includes a main translucent region and a sub translucent region disposed adjacent to each other; and a color filter structure disposed in the translucent region, wherein the color filter structure includes a first color filter layer, a second color filter layer, a third color filter layer, a first sub color filter layer disposed oppositely to the first color filter layer, a second sub color filter layer disposed oppositely to the second color filter layer, and a third sub color filter layer disposed oppositely to the third color filter layer; wherein the first color filter layer, the second color filter layer, the third color filter layer are disposed in the main translucent region; and the first sub color filter layer, the second sub color filter layer, and the third sub color filter layer are disposed in the sub translucent region.

The objects and technical solutions of the present invention can be further implemented by following technical configuration and means.

In another perspective, the present liquid crystal display panel comprises: a first substrate plate having a plurality of pixel regions, wherein the first substrate plate comprises a first substrate and a first insulating layer formed on the first substrate; a second substrate plate disposed oppositely to the first substrate plate; a liquid crystal layer disposed between the first substrate plate and the second substrate plate; and a pixel structure disposed between the first substrate plate and the second substrate plate.

In another perspective, the present manufacturing method of a liquid crystal display panel, comprises steps of: forming a first substrate; forming a first insulating layer on the first substrate; sequentially forming a plurality of color filter layers parallel to each other on the first insulating layer to form a color filter; forming a protection layer on the color filter simultaneously; and forming a first electrode layer on the protection layer to form a first substrate plate; providing a second substrate plate oppositely to the first substrate plate, wherein light spacers are disposed between the first substrate plate and the second substrate for defining a liquid crystal space and filling the liquid crystal space; and forming a liquid crystal layer between the first substrate plate and the second substrate.

In one embodiment of the present invention, the first color filter layer, the second color filter layer, and the third color filter layer are disposed on locations oppositely to the first sub color filter layer, the second sub color filter layer and the third sub color filter layer, respectively.

In one embodiment of the present invention, the first sub color filter layer, the second sub color filter layer and the third sub color filter layer are disposed adjacent to each other.

In one embodiment of the present invention, an area ratio of the main translucent region to the sub translucent region is from 1.5 to 4.

In one embodiment of the present invention, the input voltages of the main translucent region and the sub translucent region can be adjusted to make the brightness of the main translucent region greater than the brightness of the sub translucent region, wherein the input voltage of the main translucent region is greater than the input voltage of the sub translucent region.

In one embodiment of the present manufacturing method, the foregoing step of sequentially forming the plurality of color filter layers on the first insulating layer to form the color filter comprises: forming a light shading layer on the first insulating layer for covering the first insulating layer; disposing a photomask on the light shading layer, wherein the photomask includes a translucent region, an opaque region and a half-translucent region; and performing an exposure process and a development process for patterning the light shading layer to form the color filter; wherein the first color filter layer, the second color filter layer, and the third color filter layer are sequentially disposed in the main translucent region, at the same time, the first sub color filter layer, the second sub color filter layer, and the third sub color filter layer are disposed in the sub translucent region by using the same photomask simultaneously.

In one embodiment of the present manufacturing method, the foregoing step of sequentially forming the plurality of color filter layers on the first insulating layer to form the color filter comprises: forming a light shading layer on the first insulating layer for covering the first insulating layer; disposing a photomask on the light shading layer, wherein the photomask includes a translucent region, an opaque region and a half-translucent region; and performing an exposure process and a development process for patterning the light shading layer to form the color filter; wherein the first color filter layer, the second color filter layer, and the third color filter layer are sequentially disposed in the main translucent region, thereafter, the first sub color filter layer, the second sub color filter layer, and the third sub color filter layer are then sequentially disposed in the sub translucent region.

The advantages of the present invention include improving the transmittance of pixels, solving a whitening problem in a gray scale effectively for the large angle of view, and resolving a color cast problem for a liquid crystal display panel.

### BRIEF DESCRIPTION OF THE DRAWINGS

FIG. 1a shows an example of transmittance-gray scale curve diagram for a vertical alignment (VA) type liquid crystal display corresponding to color cast angles of 0 degrees angle of view, 45 degrees angle of view and 60 degrees angle of view.

FIG. 1b shows an example of brightness-gray scale curve diagram corresponding to an improved color cast angle of mixed two kinds of pixels in both bright regions and dark regions.

FIG. 2 shows an example model of mixing low color cast regions.

FIG. 3a shows a diagram illustrating color filter layers driven at different translucent regions according to one embodiment of the present invention.

FIG. 3b shows an equivalent circuit diagram illustrating color filter layers driven at different translucent regions according to one embodiment of the present invention.

FIG. 4a shows a cross-sectional view illustrating an insulating layer applied to a color filter on a thin film transistor (TFT) substrate according to one embodiment of the present manufacturing method.

FIG. 4b shows a cross-sectional view illustrating a photomask layer applied to a color filter on a thin film transistor (TFT) substrate according to one embodiment of the present manufacturing method.

FIG. 4c shows a cross-sectional view illustrating a red color filter layer applied to a color filter on a thin film transistor (TFT) substrate according to one embodiment of the present manufacturing method.

FIG. 4d shows a cross-sectional view illustrating a green color filter layer applied to a color filter on a thin film transistor (TFT) substrate according to one embodiment of the present manufacturing method.

FIG. 4e shows a cross-sectional view illustrating a blue color filter layer applied to a color filter on a thin film transistor (TFT) substrate according to one embodiment of the present manufacturing method.

FIG. 4f shows a cross-sectional view illustrating a white color filter layer applied to a color filter on a thin film transistor (TFT) substrate according to one embodiment of the present manufacturing method.

FIG. 4g shows a cross-sectional view illustrating a protection layer applied to a color filter on a thin film transistor (TFT) substrate according to one embodiment of the present manufacturing method.

FIG. 4h shows a cross-sectional view illustrating a pixel electrode layer applied to a color filter on a thin film transistor (TFT) substrate according to one embodiment of the present manufacturing method.

### DESCRIPTION OF THE PREFERRED EMBODIMENTS

The drawings as referred to following embodiments throughout the description of the present invention are examples for implementing the objects of the present invention. The orientation words or terms used in the description of the present invention, such as “above”, “under”, “forward”, “backward”, “left”, “right”, “inner”, “outer”, “side”, etc. are examples in the drawings for illustrative purpose only, or just show the interrelations between the components, but not to be construed as limitations to the scope of the present invention.

The drawings and the description of the present invention are deemed to be examples but not limitations essentially. In the drawings, components or elements having similar or same structure are marked with the same numbers. In addition, sizes and thicknesses of every component or element are just examples, but not drawn according to the actual scale and not read as limitations to the scope of the present invention.

In drawings of the present invention, sizes and thicknesses of layers, films, panels, or regions are emphasized for clearness, easy to describe and easy to understand. Therefore, some layers, films, or regions are emphasized but not drawn according to their actual scales. It is to be understood that, for example, when one of the components of layers, films, regions, or substrate are “on” another component of layers, films, regions, or substrate, the one of the components of layers, films, regions, or substrate could be adjacent on another component of layers, films, regions, or substrate directly, or there could be other inter-components of layers, films, regions, or substrate disposed therebetween.

Furthermore, in the description of the present invention, a word “comprising” or “including” is construed to comprise or include the related components, but not exclude other components, except there is clearly opposite word or description in the present invention. And, in the description of the present invention, a word “on” can be construed to be above or under a target component, but not only construed to be on a top of the target component in vertical or gravity direction.

For further clarifying the technical solutions or functions of the present invention to implement the objects of the present invention, a pixel structure, a display panel using the same, and manufacturing method thereof, and their specific implementations, structures, features and functions, according to a preferred embodiment of the present invention will be apparent from the following detailed description with reference to the accompanying drawings.

The present liquid crystal display (LCD) apparatus can include a backlight module and a liquid crystal display. The liquid crystal display can include a thin film transistor (TFT) substrate, a color filter (CF) substrate, and a liquid crystal layer formed between the thin film transistor (TFT) substrate and the color filter (CF) substrate.

In one embodiment of the present invention, the liquid crystal display panel can be a curved display panel, and the display apparatus can be a curved display apparatus.

In one embodiment of the present invention, the thin film transistor (TFT) substrate and the color filter (CF) substrate can be formed on the same substrate.

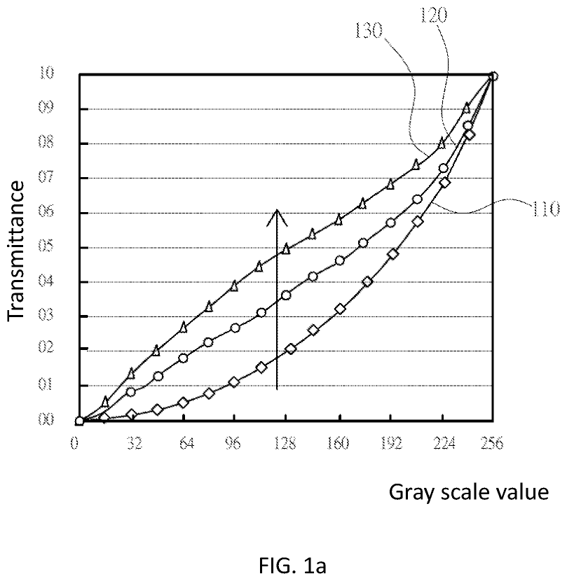

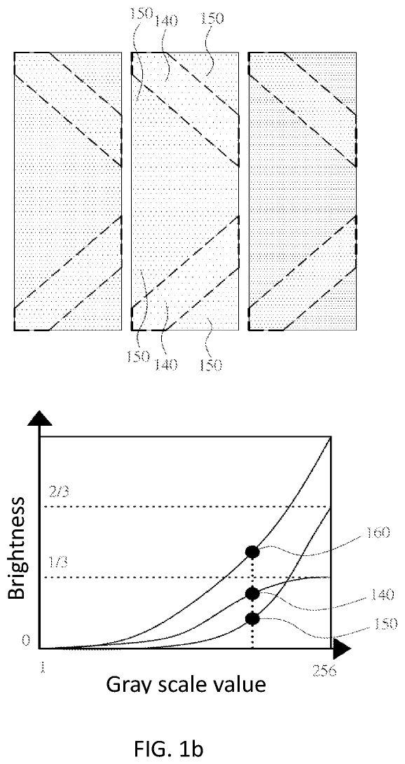

FIG. 1a shows an example of transmittance-gray scale value curve diagram for a vertical alignment (VA) type liquid crystal display corresponding to color cast angles of 0 degrees angle of view, 45 degrees angle of view and 60 degrees angle of view. Please refer to FIG. 1a, a transmittance—gray scale value curve 110 in 0 degrees color cast angle of view, a transmittance—gray scale value curve 120 in 45 degrees color cast angle of view, and a transmittance—gray scale value curve 130 in 60 degrees color cast angle of view are shown respectively. As shown in FIG. 1a, with the higher the color cast angle, the higher the brightness or the transmittance in the same gray scale value.

FIG. 1b shows an example of brightness-gray scale curve diagram corresponding to an improved color cast angle of mixed two kinds of pixels in both bright regions and dark regions. Please refer to FIG. 1b, in one embodiment of the present invention, in the multi-domain vertical alignment (MVA) type liquid crystal display, a current mainstream method is to divide a pixel into bright regions and dark regions, so that two transmittance-voltage (VT) features can be mixed for good optical performance. In addition, if the proportion of bright regions and dark regions can be adjusted properly, a whitening problem in a gray scale will be effectively solved for the large angle of view.

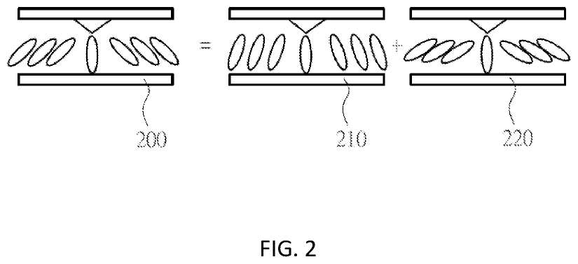

FIG. 2 shows an example model of mixing low color cast regions. Please refer to FIG. 2, in one embodiment of the present invention, a main principle of a general technique of mixing low color cast regions (called Low Color Shift) is: traditional four regions are divided into eight regions by a voltage division process or extra driving process. Therefore, an effect of multi-region compensation can be obtained in the large angle of view. For example, a sub low color cast region 210 and a main-low color cast region 220 are mixed to form a middle-low color cast region 200.

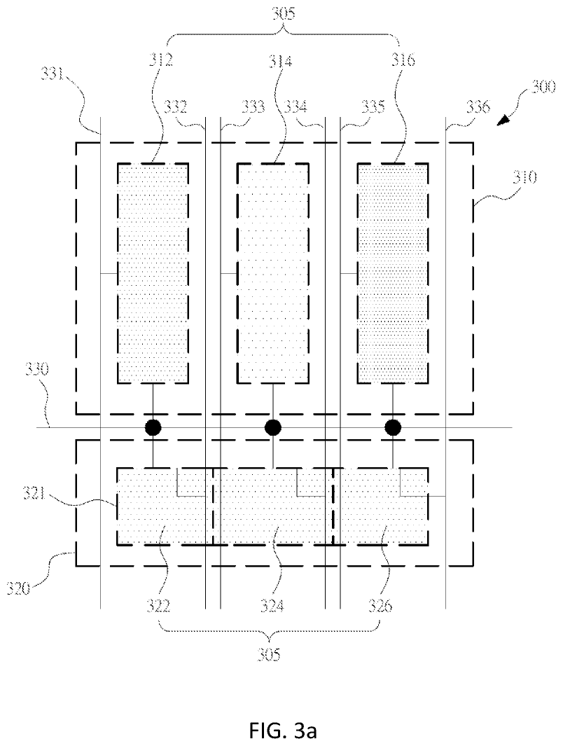

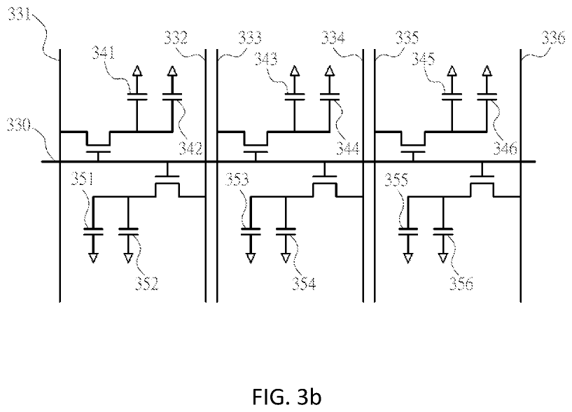

FIG. 3a shows a diagram illustrating color filter layers driven at different translucent regions according to one embodiment of the present invention, and FIG. 3b shows an equivalent circuit diagram illustrating color filter layers driven at different translucent regions according to one embodiment of the present invention. Please refer to FIGS. 3a and 3b, in one embodiment of the present invention, a pixel structure comprises a plurality of pixel units, wherein each of the plurality of pixel unit comprises: a translucent region 300, wherein the translucent region 300 includes amain translucent region 310 and a sub translucent region 320 disposed adjacent to each other; a color filter structure 305 disposed in the translucent region 300, wherein the color filter structure 305 includes a first color filter layer (red color filter layer) 312, a second color filter layer (green color filter layer) 314, a third color filter layer (blue color filter layer) 316, a first sub color filter layer (sub red color filter layer) 322 disposed corresponding to the first color filter layer 312, a second sub color filter layer (sub green color filter layer) 324 disposed corresponding to the second color filter layer 314, and a third sub color filter layer (blue color filter layer) 326 disposed corresponding to the third color filter layer 316. The red color filter layer 312, the green color filter layer 314, and the blue color filter layer 316 are disposed in the main translucent region 310. The sub red color filter layer 322, the sub green color filter layer 324, and the sub blue color filter layer 326 are disposed in the sub translucent region 320.

In one embodiment of the present invention, the red color filter layer 312, the green color filter layer 314, and the blue color filter layer 316 are disposed on locations oppositely to the sub red color filter layer 322, the sub green color filter layer 324 and the sub blue color filter layer 326, respectively.

In one embodiment of the present invention, the sub red color filter layer 322, the sub green color filter layer 324, and the sub blue color filter layer 326 are disposed adjacent to each other.

In one embodiment of the present invention, the area ratio of the main translucent region 310 to the sub translucent region 320 is from 1.5 to 4.

In one embodiment of the present invention, the present invention can adjust the input voltages of the main translucent region 310 and the sub translucent region 320 to make the brightness of the main translucent region 310 greater than the brightness of the sub translucent region 320, wherein the input voltage of the main translucent region 310 is greater than the input voltage of the sub translucent region 320, so that the brightness of the main translucent region 310 and the brightness of the sub translucent region 320 are different.

In one embodiment, the present invention can adjust the voltages of data lines 331, 333, and 335 in the main translucent region 310 and data lines 332, 334, and 336 in the sub translucent region 320 to make the brightness of the main translucent region 310 greater than the brightness of the sub translucent region 320.

In one embodiment of the present invention, as shown in FIG. 3b, equivalent driving circuits of different color filter layer corresponding to different translucent regions 310 and 320 comprises: a plurality of main liquid crystal capacitors 341, 343, and 345; a plurality of main storage capacitors 342, 344, and 346; a plurality of sub liquid crystal capacitors 351, 353, and 355; a plurality of sub storage capacitors 352, 354, and 356; a plurality of scan lines 330 and a plurality of data lines 331, 332, 333, 334, 335, and 336; wherein the plurality of scan lines 330 electrically connect with the plurality of data lines 331, 332, 333, 334, 335, and 336.

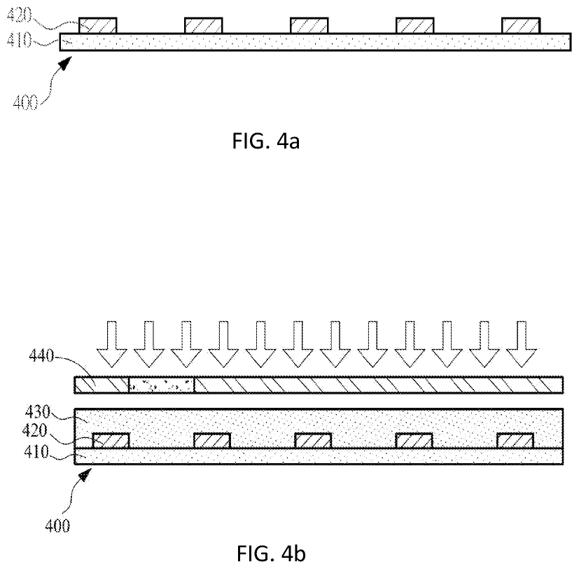

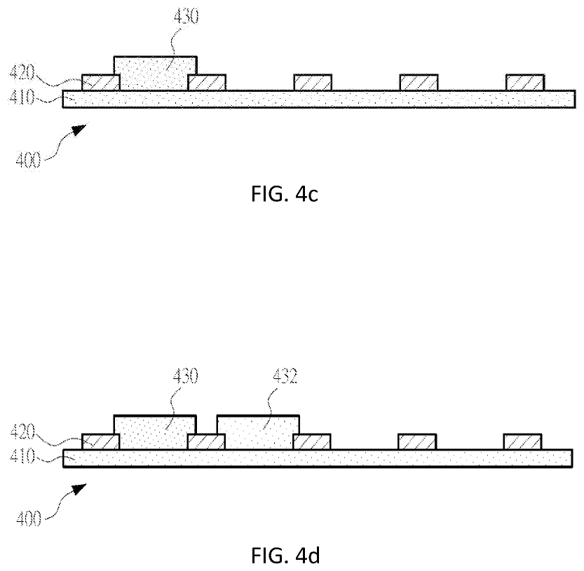

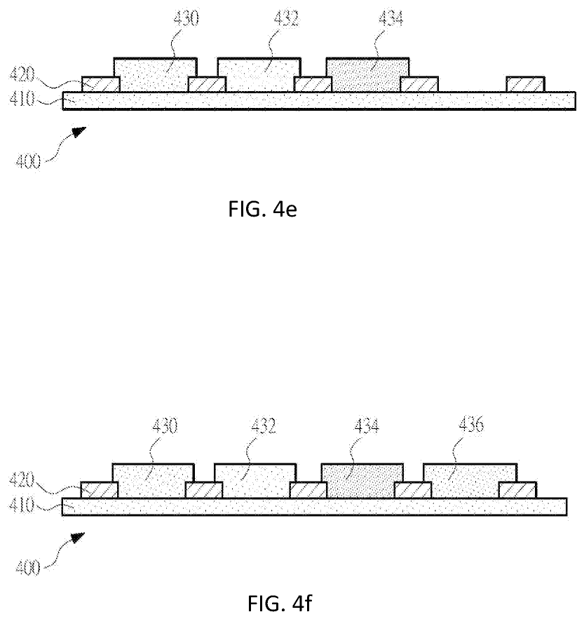

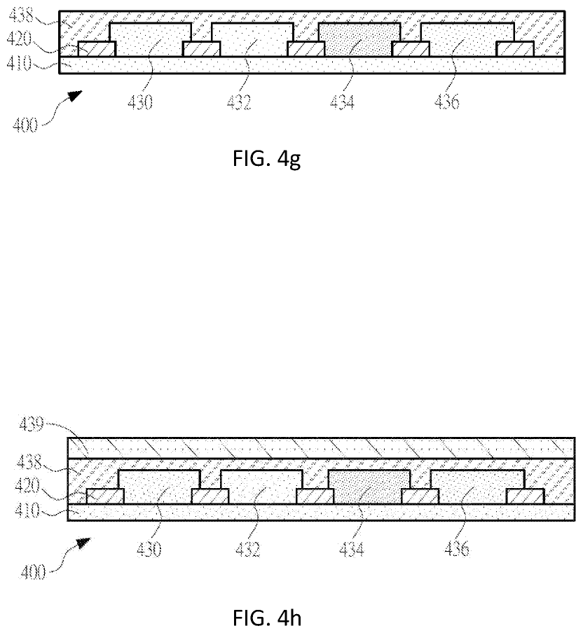

FIG. 4a shows a cross-sectional view illustrating an insulating layer applied to a color filter on a thin film transistor (TFT) substrate according to one embodiment of the present manufacturing method. FIG. 4b shows a cross-sectional view illustrating a photomask layer applied to a color filter on a thin film transistor (TFT) substrate according to one embodiment of the present manufacturing method. FIG. 4c shows a cross-sectional view illustrating a red color filter layer applied to a color filter on a thin film transistor (TFT) substrate according to one embodiment of the present manufacturing method. FIG. 4d shows a cross-sectional view illustrating a green color filter layer applied to a color filter on a thin film transistor (TFT) substrate according to one embodiment of the present manufacturing method. FIG. 4e shows a cross-sectional view illustrating a blue color filter layer applied to a color filter on a thin film transistor (TFT) substrate according to one embodiment of the present manufacturing method. FIG. 4f shows a cross-sectional view illustrating a white color filter layer applied to a color filter on a thin film transistor (TFT) substrate according to one embodiment of the present manufacturing method. FIG. 4g shows a cross-sectional view illustrating a protection layer applied to a color filter on a thin film transistor (TFT) substrate according to one embodiment of the present manufacturing method. FIG. 4h shows a cross-sectional view illustrating a pixel electrode layer applied to a color filter on a thin film transistor (TFT) substrate according to one embodiment of the present manufacturing method. Please refer to FIGS. 4a to 4h, in one embodiment of the present invention, a liquid crystal display panel comprises a first substrate plate 400 having a plurality of pixel regions. The first substrate plate 400 comprises: a first substrate 410; a first insulating layer 420 formed on the first substrate 410; a second substrate (not shown) disposed oppositely to the first substrate 410; and a second substrate plate (not shown) disposed between the first substrate plate 400 and the second substrate plate. The present invention further comprises a pixel structure disposed between the first substrate plate 400 and the second substrate plate.

In one embodiment of the present invention, a display apparatus comprises a backlight module and a liquid crystal display panel. The liquid crystal display panel comprises a first substrate plate 400 having a plurality of pixel regions. The first substrate plate 400 comprises: a first substrate 410; a first insulating layer 420 formed on the first substrate 410. The liquid crystal display panel further comprises a second substrate plate (not shown) disposed oppositely to the first substrate plate 400; and a liquid crystal layer (not shown) disposed between the first substrate plate 400 and the second substrate plate. The present invention further comprises a pixel structure disposed between the first substrate plate 400 and the second substrate.

Please refer to FIGS. 4a to 4h and 3a, in one embodiment of the present invention, a manufacturing method of a liquid crystal display panel comprises steps of: providing a first substrate 410; forming a first insulating layer 420 on the first substrate 410; sequentially forming a plurality of color filter layers 430, 432, 434, and 436 on the first insulating layer 420 to form a color filter, wherein color filter layers 430, 432, 434, and 436 are parallel to each other; simultaneously forming a protection layer 438 on the color filter; and forming a first electrode layer 439 on the protection layer 438. Thereby, a first substrate plate 400 has been completed. The present manufacturing method further comprises: providing a second substrate plate disposed oppositely to the first substrate plate 400, wherein light spacers are disposed between the first substrate plate 400 and the second substrate for defining a liquid crystal space and filling the liquid crystal space; and forming a liquid crystal layer between the first substrate plate 400 and the second substrate.

In one embodiment, the present manufacturing step of sequentially forming the plurality of color filter layers 430, 432, 434, and 436 on the first insulating layer 420 to form the color filter comprises: forming a light shading layer on the first insulating layer 420 for covering the first insulating layer 420; disposing a photomask 440 on the light shading layer, wherein the photomask 440 includes a translucent region, an opaque region and a half-translucent region; and performing an exposure process and a development process for patterning the light shading layer to form the color filter, wherein the red color filter layer 312, the green color filter layer 314, and blue color filter layer 316 are sequentially disposed in the main translucent region 310, at the same time, the sub red color filter layer 322, the sub green color filter layer 324, and the sub blue color filter layer 326 are disposed in the sub translucent region 320 by using the same photomask 400 simultaneously.

In one embodiment, the present manufacturing step of sequentially forming the plurality of color filter layers 430, 432, 434, and 436 on the first insulating layer 420 to form the color filter comprises: forming a light shading layer on the first insulating layer 420 for covering the first insulating layer 420; disposing a photomask 440 on the light shading layer, wherein the photomask 440 includes a translucent region, an opaque region and a half-translucent region; and performing an exposure process and a development process for patterning the light shading layer to form the color filter, wherein the red color filter layer 312, the green color filter layer 314, and the blue color filter layer 316 are sequentially disposed in the main translucent region 310; thereafter, the sub red color filter layer 322, the sub green color filter layer 324, and the sub blue color filter layer 326 are sequentially disposed in the sub translucent region 320.

The present invention can improve the transmittance of pixels, solve a whitening problem in a gray scale effectively for the large angle of view, and resolve a color cast problem for a liquid crystal display panel.

“In some embodiments of the present invention” and “In a variety of embodiments of the present invention” are used repeatedly through the description. They usually mean different embodiments. However, they can also mean the same embodiments. “Comprising”, “having” and “including” are synonyms, except it is noted to be different or has other meaning before and after its description.

The present invention has been described in considerable detail with reference to certain preferred embodiments thereof. It should be understood that the description is for illustrative purpose, not for limiting the scope of the present invention. Those skilled in this art can readily conceive simple or equivalent variations and modifications, which are still within the spirit of the present invention.

What is claimed is:

1. A pixel structure having a plurality of pixel units, wherein each of the pixel units comprises:
a translucent region, including a main translucent region and a sub translucent region disposed adjacent to each other; and
a color filter structure disposed in the translucent region, wherein the color filter structure includes a first color filter layer, a second color filter layer, a third color filter layer, a first sub color filter layer disposed oppositely to the first color filter layer, a second sub color filter layer disposed oppositely to the second color filter layer, and a third sub color filter layer disposed oppositely to the third color filter layer;
wherein the first color filter layer, the second color filter layer, the third color filter layer are disposed in the main translucent region; and the first sub color filter layer, the second sub color filter layer, the third sub color filter layer are disposed in the sub translucent region.

2. The pixel structure according to claim 1, wherein the first color filter layer, the second color filter layer, and the third color filter layer are disposed on locations oppositely to the first sub color filter layer, the second sub color filter layer and the third sub color filter layer respectively.

3. The pixel structure according to claim 1, wherein the first sub color filter layer, the second sub color filter layer and the third sub color filter layer are disposed adjacent to each other.

4. The pixel structure according to claim 1, wherein an area ratio of the main translucent region to the sub translucent region is from 1.5 to 4.

5. The pixel structure according to claim 1, wherein the input voltages of the main translucent region and the sub translucent region are adjusted to make the brightness of the main translucent region greater than the brightness of the sub translucent region.

6. The pixel structure according to claim 5, wherein the input voltage of the main translucent region is greater than the input voltage of the sub translucent region.

7. A liquid crystal display panel, comprising:
a first substrate plate having a plurality of pixel regions, the first substrate plate comprising:
a first substrate; and
a first insulating layer formed on the first substrate;
a second substrate plate disposed oppositely to the first substrate plate;
a liquid crystal layer disposed between the first substrate plate and the second substrate plate; and
a pixel structure having a plurality of pixel units, each of the pixel units comprising:
a translucent region, wherein the translucent region includes a main translucent region and a sub translucent region disposed adjacent to each other;
a color filter structure disposed in the translucent region, wherein the color filter structure includes a first color filter layer, a second color filter layer, a third color filter layer, a first sub color filter layer disposed oppositely to the first color filter layer, a second sub color filter layer disposed oppositely to the second color filter layer, and a third sub color filter layer disposed oppositely to the third color filter layer;
wherein the first color filter layer, the second color filter layer, the third color filter layer are disposed in the main translucent region; and the first sub color filter layer, the second sub color filter layer, the third sub color filter layer are disposed in the sub translucent region;
wherein the pixel structure is disposed between the first substrate plate and the second substrate plate.

8. The liquid crystal display panel according to claim 7, wherein the first color filter layer, the second color filter layer, and the third color filter layer are disposed on locations oppositely to the first sub color filter layer, the second sub color filter layer and the third sub color filter layer respectively.

9. The liquid crystal display panel according to claim 7, wherein the first sub color filter layer, the second sub color filter layer and the third sub color filter layer are disposed adjacent to each other.

10. The liquid crystal display panel according to claim 7, wherein the area ratio of the main translucent region to the sub translucent region is from 1.5 to 4.

11. The liquid crystal display panel according to claim 7, wherein the input voltages of the main translucent region and the sub translucent region are adjusted to make the brightness of the main translucent region greater than the brightness of the sub translucent region.

12. The liquid crystal display panel according to claim 11, wherein the input voltage of the main translucent region is greater than the input voltage of the sub translucent region.

13. A manufacturing method of a liquid crystal display panel, comprising steps of:
forming a first substrate;
forming a first insulating layer on the first substrate;
sequentially forming a plurality of color filter layers parallel to each other on the first insulating layer to forma color filter;
forming a protection layer on the color filter simultaneously; and
forming a first electrode layer on the protection layer to form a first substrate plate;
providing a second substrate plate oppositely to the first substrate plate, wherein light spacers are disposed between the first substrate plate and the second substrate for defining a liquid crystal space and filling the liquid crystal space; and
forming a liquid crystal layer between the first substrate plate and the second substrate.

14. The method of manufacturing the liquid crystal display panel according to claim 13, wherein the step of sequentially forming the plurality of color filter layers on the first insulating layer to form the color filter comprises:
forming a light shading layer on the first insulating layer for covering the first insulating layer;
disposing a photomask on the light shading layer, wherein the photomask includes a translucent region, an opaque region and a half-translucent region;
and performing an exposure process and a development process for patterning the light shading layer to form the color filter;
wherein the first color filter layer, the second color filter layer, and the third color filter layer are sequentially disposed in the main translucent region, at the same time, the first sub color filter layer, the second sub color filter layer, and the third sub color filter layer are disposed in the sub translucent region by using the photomask simultaneously.

15. The manufacturing method of the liquid crystal display panel according to claim 13, wherein the step of sequentially forming the plurality of color filter layers on the first insulating layer to form the color filter comprises:
forming a light shading layer on the first insulating layer for covering the first insulating layer;
disposing a photomask on the light shading layer, wherein the photomask includes a translucent region, an opaque region and a half-translucent region;
and performing an exposure process and a development process for patterning the light shading layer to form the color filter;
wherein the first color filter layer, the second color filter layer, and the third color filter layer are sequentially disposed in the main translucent region, thereafter, the first sub color filter layer, the second sub color filter layer, and the third sub color filter layer are then sequentially disposed in the sub translucent region.
